(19) United States
(12) Patent Application Publication
(10) Pub. No.: US 2017/0265444 A1
(43) Pub. Date: Sep. 21, 2017

(54) FISHING LURE

(71) Applicant: BnR Tackle LLC, Origin, OR (US)

(72) Inventor: Brandon G. Wedam, Origin, OR (US)

(21) Appl. No.: 15/617,705

(22) Filed: Jun. 8, 2017

Related U.S. Application Data
(63) Continuation-in-part of application No. 13/734,898, filed on Jan. 4, 2013, now abandoned.
(60) Provisional application No. 61/631,542, filed on Jan. 5, 2012.

(51) Int. Cl. A01K 85/16; A01K 99/00

(52) U.S. Cl. CPC A01K 85/16; A01K 99/00

(57) ABSTRACT

The disclosed artificial fishing lures have an elongated, flexible body with a pre-formed hole through the body. The hole has a longitudinal portion that extends along a central axis of the body some length, which in some examples is at least mid-way along the entire length of the body of the lure. The hole has a second portion that extends from the central axis at an angle to cause the hole to end on an exterior surface of the body of the lure. The hole is large enough to allow the fishing lure to slide along a fishing line that is threaded through the hole. The hole diameter is larger than the diameter of the line, in some example 50% larger, and is smaller than a diameter of a fishing hook attached to the end of the line, which allows the fishing lure to slide along the line easily and be stopped by the fishing hook so it does not slide off the line and hook combination. Other lure stops can be used as well.

### CROSS REFERENCE TO RELATED APPLICATIONS

This application is a Continuation-in-Part of U.S. Non-Provisional application Ser. No. 13/734,898, entitled, “Partially Cannulated Fishing Worm,” filed Jan. 4, 2013, which claims priority and benefit from the U.S. Provisional Patent Application 61/631542, filed Jan. 5, 2012 and titled, “Cannulated plastic fishing worm,” which are incorporated herein by reference in their entirety for all purposes.

### BACKGROUND

Most anglers are passionate about fish and the equipment they use to catch them. Some anglers even refer to fishing as a religion or an addiction and take great care preparing their equipment to maximize the experience and pleasure of catching fish. Anglers tend to use a variety of lures, including a combination of live bait and artificial lures. Steelhead and salmon anglers, for example, may use artificial lures that resemble common food sources for the fish they wish to catch. Artificial lures provide anglers with a wide variety of options to entice fish to bite. Oftentimes, artificial lures include a flexible, elastic material or have joints that move in a similar manner to the live bait they emulate. When threading flexible, elastic material onto a fishing line, anglers typically pierce a solid, flexible lure with the hook or a line threader and slide the hook or line threader through the entire length of the lure or some portion of it. The line threading process can be lengthy and difficult, especially when trying to do so under unfavorable weather or lighting conditions, which often happen during a fishing trip.

Flexible lures that have been pierced and threaded in a conventional manner tend to have significant friction between the line and the piercing through the lure which makes the lures become difficult to move along the line. When they do move, such as when the lure and hook float through the water during use, they can suffer from “lure scrunch” in which the lure migrates away from the angler towards the hook and collapses onto itself, sometimes creeping onto a portion of the hook as well. Because of the significant friction between the lure and the line, the lure remains in this collapsed state until the angler manually stretches the lure back to its elongated position. Even further, when the angler hooks a fish using a conventional lure, the fish thrashes around and usually shakes its head from side to side in a violent manner to escape being caught. Such thrashing frequently damages the flexible lure to a level that requires the lure to be replaced with a new lure on subsequent casts, which causes delay and adds expense.

The art would benefit from a new fishing system with a lure that is easily and efficiently attached to a fishing line and hook and that can be reusable for catching multiple fish.

### SUMMARY

The disclosed artificial fishing lures have an elongated, flexible body and a pre-formed hole that extends from the first end towards the second end of the body. The body has an exterior surface and a central axis through its length that extends from the first end to the second end. The pre-formed hole has a first portion that begins at the first end of the body and extends along the central axis and a second portion that begins at a mid-way point along the central axis between the first end and the second end of the body. The second portion extends at an angle away from the central axis and terminates on the exterior surface of the body.

A fishing system including this artificial lure can additionally include a fishing line and a hook. The fishing line has a line diameter and extends through the pre-formed hole. A first end of the line is attachable to a fishing apparatus, like a rod and reel combination, for example. The second, opposing end of the fishing line is attached to a hook. An angler inserts a first end of the fishing line into an entry point of the pre-formed hole in the disclosed fishing lures and slides the lure along the line so the line exits the pre-formed hole at an exit point that is mid-way along the length of the body of the fishing lure and extends away from the central axis. The first end of the fishing line is secured to a line hook at an attachment point and the opposing second end of the fishing line can be secured to a fishing rod and reel selected by the angler.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 shows a side plan view of an example fishing lure system with a fishing lure, a line, and an attached fishing hook, in accordance with the disclosure.

FIG. 2 is a front plan view of the fishing lure shown in the system of FIG. 1.

FIG. 3 is a back plan view of the fishing lure shown in the system of FIG. 1.

FIG. 4 is a top plan view of the fishing lure shown in FIG. 1.

FIG. 5 is a cross-sectional view of the fishing lure shown in FIG. 4, taken along line 5-5.

FIG. 6 is a cross-sectional view of another example fishing lure.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

The disclosed artificial fishing lures, systems, and methods provide improved efficiency, efficacy, and durability to anglers of all types, including specifically to steelhead and salmon anglers. Conventional artificial fishing lures, specifically those designed for steelhead and salmon fishing, are time-consuming and relatively difficult to tie in less than ideal weather or lighting conditions. The disclosed inventions allow the fishing lure to freely slide along the fishing line when tied which prevents lure “scrunch” or collapsing of the lure onto itself which helps to maintain the lure in its elongated position so it resembles its live counterpart and attracts the fish more effectively. The free-sliding capabilities of the disclosed lure designs also allow the fishing lures to slide away from the hook along the line when the fish is hooked and is thrashing its head trying to escape capture, which reduces the likelihood that the lure is damaged during the catch. The disclosed fishing lures, systems, and methods provide these and other benefits to anglers.

The disclosed new fishing lure designs can be used with any type of fishing. The examples discussed in this application are specific to steelhead and salmon fishing but could be adapted, as desired, to designs for other types of fishing. Specifically, the disclosed fishing lures are shaped as a worm, grub, lizard, frog, crayfish, fish, or other fish food or attractive shape or mechanism. Other example lure bodies are generally shaped to be tapered to emulate a generic shape rather than a particular species desirable food for the target fish. The lures can be any suitable color or multiple colors, including patterns and/or designs, as desired, and can include coatings, textures, and the like.

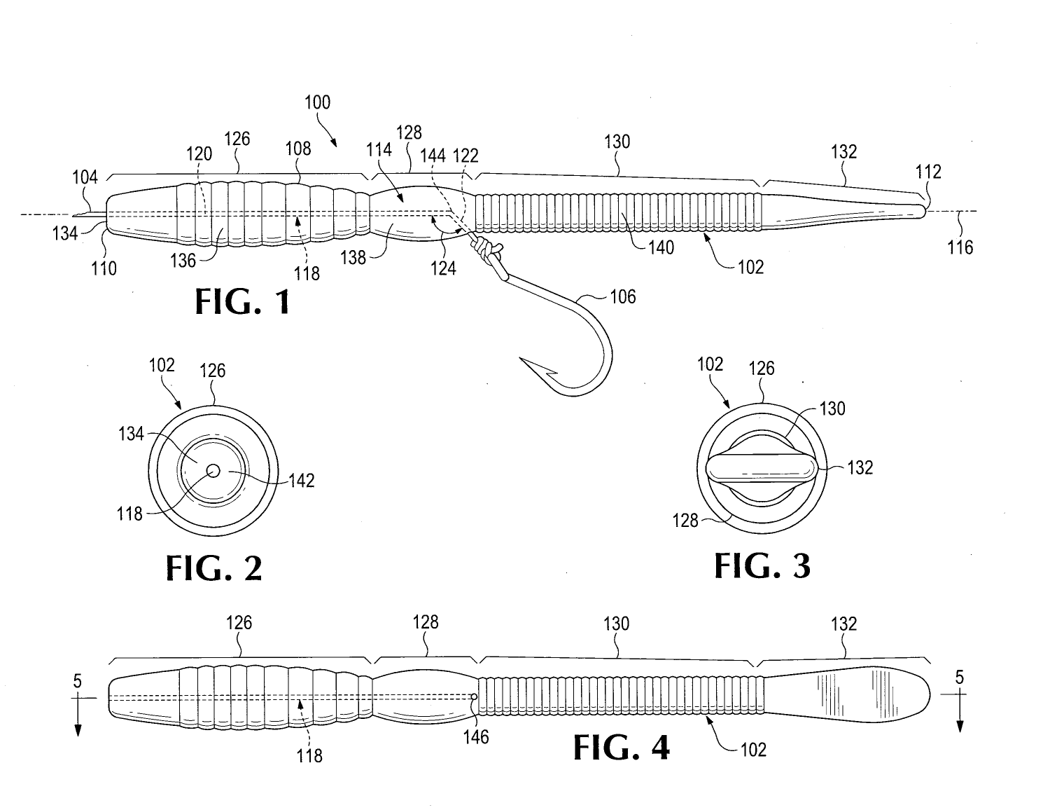

The disclosed fishing lures can be part of a fishing system, such as a traditional fishing line, rod, and reel combination. The example system 100 shown in FIG. 1 includes a fishing lure 102, part of a fishing line 104, and a fishing hook 106. The disclosed fishing lure, such as the lure 102 shown in FIG. 1, has a fishing line 104 inserted through its pre-formed hole 118 that is attached to a hook 106. In the example shown in FIG. 1, the hook 106 is attached to the line 104 using a traditional fisherman's line knot, but could be attached in any other desirable way. The fishing line 104, in this example, is inserted through an eye (not shown) on the hook 106 before being tied in a line knot. Other suitable techniques can be used to secure the line 104 and hook 106 together. In this example, the line knot provides a natural line stop that prevent the proximal end of the hook from being retracted into the hole 118 during use. A diameter of the pre-formed hole 118 is formed based on the diameter of the fishing line 104. Oftentimes, lure manufacturers anticipate a range of line diameters that are likely to be used with a particular lure and with it, a particular type of hook. The usual line stop or eye of the hook for the hooks commonly used with a particular lure can determine the hole diameter of the fishing lure. For example, the hole could have a diameter than is less than a diameter of the eye of the hook in the example shown in FIG. 1. The hole diameter can be selected based on the known type of hook and, more specifically, the diameter of the eye of the hook or any other attachment mechanism for the line to be attached to the hook to prevent the hook from becoming wedged into the fishing lure or from slipping off the fishing lure entirely.

The disclosed pre-formed hole 118 of the fishing lure 102 can be selected based on the diameter or range of diameters for lines that are most likely to be used with the particular fishing lure 102 to provide ideal or near ideal conditions for allowing the fishing lure 102 to freely slide along the line 104. The careful selection of the diameter of the pre-formed hole 118 extends durability of the fishing lure 102 which allows anglers to re-use the fishing lure or may increase the number of times that anglers can re-use the fishing lure.

Either the fishing line 104, the interior wall of the hole 118, or both can be coated with a lubricant that facilitates movement of the fishing line 104 within the hole 118 and reduces frictional forces between the two as they slide against each other. Any suitable lubricant can be used including, oils, saliva, and other fluids. The line 104 can also be coated with a scent, as desired, which can be in addition to a lubricant or the coating could serve as both a lubricant and a scent in one. Other coatings to the line and/or the interior of the hole can be used, as desired.

In this example, the fishing lure 102 has an elongated, flexible body 108 with a first end 110 and a second end 112. The body 118 is any suitable length and has an exterior surface 114 and a central axis 116 defined along its longitudinal length. For example, the body 108 is shaped as a worm, as shown in FIG. 1, and can be 3.5 inches or 5 inches long. The body 108 can be any other desired length that resembles common food for the target fish. The fishing lure 102 also has a pre-formed hole 118 through the body that extends from the first end 110 to the second end 112. The pre-formed hole 118 has a first portion 120 and a second portion 122. The first portion 120 of the pre-formed hole 118 begins at the first end 110 of the body and ends along the central axis 116. The second portion 122 of the pre-formed hole 118 begins at an approximately mid-way point along the central axis 116 between the first end 116 and the second end 118 of the body 108 of the lure 102. The mid-way point along the central axis 116 can be anywhere in a middle portion of the body 108. In the example shown in FIG. 1, the mid-way point is within the central section 128 of the worm body 108, but it could be anywhere past the mid-way point of the nose section through the rear section of the lure body.

The elongated, flexible body 108 can include any suitable material, such as flexible soft plastic polymers and can be colored, painted, textured or otherwise decorated with a design of texture of any desired kind. In some example designs, the material used for the lure body 108 has either a positive buoyancy, negative buoyancy or a neutral buoyancy characteristic when emerged in water. The average density of the fishing lure can be adjusted to be approximately equal to, for neutral buoyancy, or less than, for positive buoyancy based on the type of fishing for which the fishing lure is intended. For example, the material could be selected based on the type of fish food that the fishing lure tries to emulate so that it appears as close to live bait as it can for the fish. Still further, the fishing lure material can be selected based on its elasticity to withstand the frictional forces applied to the lure body when the body slides along the fishing line.

The example fishing lure 102 shown in FIG. 1 is in the shape of a worm but could take on any other desirable shapes in alternative designs. The fishing lure 102 has four integral sections—a first nose section 126, a second central section 128, a third rear section 130, and a tail section 132. The first nose section 126 has a flat end 134 and curved side walls with multiple ribs of varying size. The beginning of the hole 118 that extends through the lure body 108 is located at a central position on the flat end 134. The hole 118 extends through the entirety of the first nose section 126 of the lure body 108 in the example shown in FIG. 1. The second central section 128 is positioned integrally between the nose section 126 and the rear section 130 and has curved, smooth side walls 138. The hole 108 also extends through a substantial portion of the central section 128 at which point it reaches an angled corner 144 and exits the lure body 108 at the side wall 138 of the central portion 128. The angle 124 at the corner 144 is approximately 45° with respect to the central axis 116 in the example shown in FIG. 1 and could be other angles in different designs. The third rear section 130 is positioned integrally between the central section 128 and the tail section 132. The third rear section 130 has multiple ribs and linear sidewalls 140. The tail section 132 is attached to the rear section 130 and has a tapered shape which terminates at the second end 112 of the lure body 108. The rear section 130 and the tail section 132 are both solid material and the hole does not extend through either section. Other examples could have the hole 108 extend either greater or less along the central axis 116 than the example shown in FIG. 1.

FIG. 2 shows a front plan view of the flat end 134 of the lure body 108. The first section of the worm 126 has a circular cross-section with the hole 108 in the central portion 142. FIG. 3 shows a back plan view of the tail section 132. FIG. 4 shows a top plan view of the lure body 108 showing the exit point 146 of the hole 108 through the side wall 138 of the central portion 128.

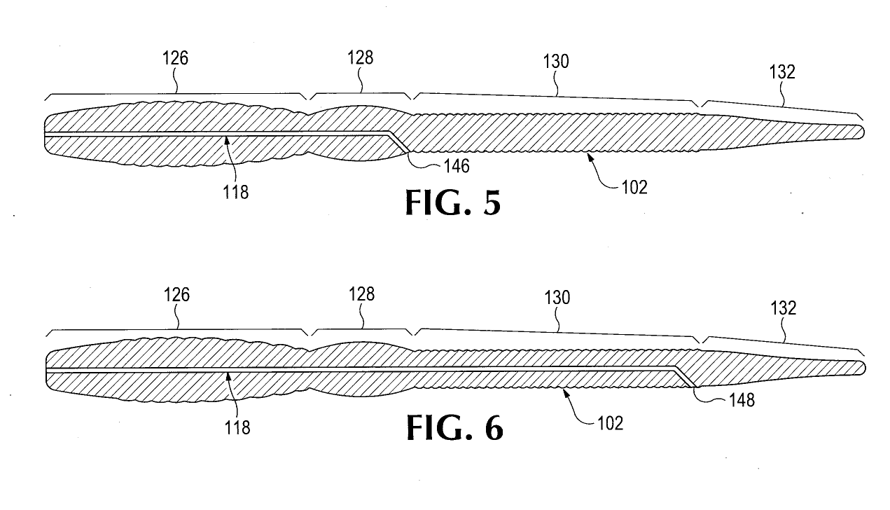

FIG. 5 is a cross-sectional view of FIG. 4 taken along line 5-5 showing the lure body 108. FIG. 6 shows the same lure body 108 shown in FIG. 5 but with a hole 108 having a longer length and extending through the rear section 130 and terminating at the tail section 132 at an exit point 148 located in the rear section 130. The hole can extend any desired length through the lure body. Other lure bodies can be used in place of the worm design shown in FIGS. 1-6. The length of the hole and the angle at which it exits the lure body in other lure designs depends on the shape of the lure body to emulate natural movement of the creature the lure body is trying to emulate. The portion of the lure body through which the hole extends and correspondingly, through which the fishing line extends when in use has restrained movement compared to the free flowing portion of the lure body that is solid and does not have a line extending through it. The remaining portion of the lure body through which the hole and line does not extend flows freely in the water as its emulated live counterpart might, such as a tail or backend of a worm or other fish might appear.

The lures disclosed in this application can be manufactured in several ways. For example, the lures can be made using an injection molding process that includes a mold having lure body cavities and wire cavities. To create a pre-formed hole through the lure body, the injection molding process can use a lubricious surface, like an electropolished stainless steel wire such as a Kirschner wire used in medical applications, which is held in place using the wire cavities. The lubricious wire is suspended through the lure body cavity. When the thermoplastic is poured into the lure body cavit(ies) of the mold, the wire extends through the thermoplastic. Once the lure body is finished curing in the mold, it is removed from the mold and the lubricious wire is removed from the hole, which produces a formed lure body with a hole that is pre-formed for an angler's use.

The pre-formed hole has a diameter that is customized to the selected fishing line, as discussed above. The line diameter and any coatings applied to the line vary with respect to the type of fishing for which the lure is typically used and the weather and environmental conditions. The internal walls of the pre-formed hole are smooth because it is created with a wire having a lubricious surface. The diameter of the pre-formed hole is also at least 50% greater than the diameter of the fishing line, in some examples, to help facilitate the fishing lure sliding along the line with little opposing frictional force. One example pre-formed hole for the disclosed fishing lures is 1/16 inches and can be other suitable dimensions, as needed. The cross-section of the pre-formed hole can be any shape. The shape shown in the examples illustrated in FIGS. 1 and 2 is round, but the shape can also be oval, square, triangular, or any other polygonal shape, as desired.

The above example lures can be used by anglers in any suitable manner. For example, an angler can insert a first end of a fishing line into an entry point of the pre-formed hole of one of the disclosed fishing lures. The angler slides the line through the pre-formed hole until the end of the line emerges from an exit point of the pre-formed hole. As discussed above, the exit point of the pre-formed hole can be mid-way along the length of the body of the fishing lure and extends at an angle with respect to the central axis of the body. The angler secures the end of the line extending from the exit point of the pre-formed hole to a fishing hook at an attachment point, such as securing it with a fisherman's knot through an eye of the fishing hook. The opposite end of the line extending from the entry point of the pre-formed hole is secured to a fishing rod and reel. No line threader is needed since the pre-formed hole guides the line through from the entry point to the exit point. Prior to inserting the fishing line into the pre-formed hole of the fishing lure, the angler can coat the line and/or any portion of the inside of the pre-formed hole with a lubricant and/or a scent. Anglers are able to re-use the disclosed fishing lures.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

What is claimed is:

1. An artificial fishing lure, comprising:
an elongated, flexible body having a first end and a second end, the body also having an exterior surface and a central axis through a length of the body from the first end to the second end; and
a pre-formed hole through the body extending from the first end towards the second end, the hole having:
a first portion beginning at the first end of the body and extending along the central axis, and
a second portion beginning at a mid-way point along the central axis between the first end and the second end of the body and extending at an angle with respect to the central axis, the second portion of the hole terminating on the exterior surface of the body.

2. The artificial fishing lure of claim 1, wherein the length of the body is either 3.5 long or 5 inches.

3. The artificial fishing lure of claim 1, wherein the body is tapered from the first end towards the second end.

4. The artificial fishing lure of claim 1, wherein the body is shaped to be any one of the following: a worm, a fish, a crayfish, a frog, a lizard, an insect, and a grub.

5. The artificial fishing lure of claim 1, wherein the body is positively buoyant, negatively buoyant or neutrally buoyant.

6. The artificial fishing lure of claim 1, wherein the hole has a diameter of 1/16 inches.

7. The artificial fishing lure of claim 1, wherein the hole has a cross-section that is circular, oval-shaped, triangular, square, rectangular, or polygonal.

8. The artificial fishing lure of claim 1, wherein the mid-way point along the central axis is at least halfway along the length of the body.

9. The artificial fishing lure of claim 1, wherein the mid-way point along the central axis is less than halfway along the length of the body.

10. The artificial fishing lure of claim 1, wherein the angle is at least 45° from the central, longitudinal axis.

11. A fishing system, comprising:
an artificial fishing lure, having:
an elongated, flexible body having a first end and a second end, the body also having an exterior surface and a central axis extending longitudinally through a length of the body from the first end to the second end; and
a pre-formed hole through the body extending from the first end towards the second end, the hole having:
a first portion beginning at the first end of the body and extending along the central axis, and
a second portion beginning at a mid-way point along the central axis between the first end and the second end of the body and extending at an angle with respect to the central axis, the second portion of the hole terminating on the exterior surface of the body;
a fishing line having a line diameter and extending through the pre-formed hole, the fishing line having a first end structured to be attached to a fishing apparatus and an opposing second end; and
a line hook having an eye and being attached to the second end of the fishing line at a hook attachment point.

12. The fishing system of claim 11, wherein the hole has a hole diameter that is at least 50% greater than the line diameter.

13. The fishing system of claim 11, wherein the hole has a hole diameter that is selected based on the line diameter of the fishing system.

14. The fishing system of claim 11, wherein the body includes a material having an elasticity sufficient to withstand friction forces created when the body slides along the fishing line without collapsing the body.

15. The fishing system of claim 11, wherein the fishing line is at least partially coated with a lubricant.

16. The fishing system of claim 11, wherein the hole has a diameter than is less than a diameter of the eye of the line hook.

17. The fishing system of claim 1, wherein the artificial fishing lure is reusable.

18. A fishing method, comprising:
inserting a first end of a fishing line into an entry point of a pre-formed hole that extends longitudinally along a central axis of an elongated, flexible body of a fishing lure;
sliding the first end of the fishing line through the pre-formed hole to an exit point of the pre-formed hole that is located mid-way along a length of the body of the fishing lure, the exit point extending at an angle with respect to the central axis to exit the body of the fishing lure;
securing the first end of the fishing line protruding from the exit point of the pre-formed hole to a line hook at an attachment point; and
attaching a second, opposing end of the fishing line to a fishing rod and reel.

19. The fishing method of claim 18, wherein the sliding the first end of the fishing line through the pre-formed hole in the body of the fishing lure is performed without a line threader.

20. The fishing method of claim 18, further comprising, after a first use of the fishing lure, reusing the fishing lure for a second use.
